(19) United States
(12) Patent Application Publication
(10) Pub. No.: US 2022/0159318 A1
(43) Pub. Date: May 19, 2022

(54) STREAMING DATA GENERATING DEVICE, STREAMING DATA DELIVERY SYSTEM, AND METHOD OF GENERATING STREAMING DATA

(71) Applicant: RADIUS CO., LTD., Tokyo (JP)

(72) Inventor: Susumu KOHDA, Tokyo (JP)

(21) Appl. No.: 17/429,668

(22) PCT Filed: Oct. 28, 2019
(86) PCT No.: PCT/JP2019/042219

§ 371 Date: Aug. 10, 2021

(30) Foreign Application Priority Data
Oct. 28, 2019 (JP) 2019-195273

(51) Int. Cl. H04N 21/2368; H04N 7/01; H04N 21/2389

(52) U.S. Cl. CPC H04N 21/2368; H04N 21/23892; H04N 7/0125

(57) ABSTRACT

An object is to provide a realistic image with sound. A streaming data generating device includes: an embedder configured to acquire a high-resolution audio signal and a 4K image signal and embed the audio signal into the image signal to obtain an embedment signal; an encoder configured to acquire the embedment signal from the embedder and encode the embedment signal by lossless compression to obtain encoded data; and a packager configured to acquire the encoded data from the encoder, convert the encoded data into streaming data, and output the streaming data.

### TECHNICAL FIELD

The present invention relate to a device and method for delivery of streaming data which achieve real-time playback of data of an image and high-resolution audio inputted from an image/audio output section in a live event site or the like without downloading them.

### BACKGROUND ART

The Applicant of the present invention has provided a display device for a portable audio apparatus (hereinafter “portable audio apparatus display device”) that can perform comparative display of the frequency band of audio that was read from outside of a portable audio apparatus main unit and is stored thereon, and the frequency band at which the portable audio apparatus main unit performs playback (Patent Literature 1).

The portable audio apparatus display device disclosed in Patent Literature 1 includes, as illustrated in FIG. 6: an audio file 18 in which a plurality of pieces of external audio data are stored; a playback unit 14 that plays back the audio data of the audio file 18; an apparatus data memory 16 that stores playback device model data; a controller 15 that controls reading and output of the audio data and reading and output of the device model data; sampling-rate output 21 that outputs sampling rate of audio data of the audio file 18; playback sampling-rate output 23 that outputs playback sampling-rate based on playback output from the controller 15 to the playback unit 14; an audio output display unit (section) 12 that displays the sampling rate from the sampling-rate output 21; and a playback output display unit (section) 13 that displays the sampling rate from the playback sampling-rate output 23. In addition to the audio data sampling-rate output 21, a file format output 20 that outputs file data of a selected one of the pieces of audio data is provided. In addition to the playback sampling-rate output 23, a device model data output 22 that outputs the selected device model data is provided. The audio output display section 12 includes: a file name display unit (section) 24 that displays the name of the file format of the audio data outputted from the file format output 20; a numeric value display unit (section) 25 which displays, in digital numerical form, the sampling rate of the audio data outputted from the sampling-rate output 21; and a bar chart display unit (section) 26 that displays, in the form of an analog bar-line chart, the sampling rate of the audio data outputted from the sampling-rate output 21. The playback output display section 13 includes: a playback device model name display unit (section) 27 that displays the name of device model data outputted from the device model data output 22; a numeric value display unit (section) 28 that displays, in digital numerical form, the sampling rate of device model data outputted from the playback sampling-rate output 23; and a bar chart display unit (section) 29 that displays, in the form of an analog bar-line chart, the sampling rate concerning device model data outputted from the playback sampling-rate output 23. The file name display section 24, the numeric value display section 25, and the bar chart display section 26 constituting the audio source output display section 12, and the playback device model name display section 27, the numeric value display section 28, and the bar chart display section 29 constituting the playback output display section 13, respectively, are arranged on top of each other in the vertical direction for comparative display.

Patent Literature 2 discloses receiving television program data at a receiving section through streaming.

According to Patent Literature 2, once a receiving section 208 has received television program data from a server 100, the receiving section 208 causes a first buffer 250 to store the television program data until data of a predetermined size is accumulated for decoding. A decoding section 222 decodes the television program data of the predetermined size stored in the first buffer, and stores it in a second buffer 252.

A synchronizing signal conditioning section 400 analyzes TS packets of Mpeg2 decoded by the decoding section 222, and then outputs the packets to a stream supplying section 256. The stream supplying section 256 stores, in a third buffer 254, the packets acquired from the synchronizing signal conditioning section 400. Once the amount of packets stored in the third buffer 254 has reached a predetermined amount, the stream supplying section 256 outputs the packets to a packet separating section 224.

The separating section 224 separates an image signal, an audio signal, and a playback timing signal from the packets of television program data acquired from the stream supplying section 256. The separating section 224 stores the image signal and the audio signal separated from the packets of the television program data in an image buffer 258 and an audio buffer 260, respectively. An image decoder 262 decodes the image signal stored in the image buffer 258 and stores it in a fourth buffer 266. Similarly, the audio decoder 264 decodes audio data stored in the audio buffer 260 and stores it in the fourth buffer 266.

### CITATION LIST

### Patent Literature

[Patent Literature 1]

Japanese Utility Model No. 3196335

[Patent Literature 2]

Japanese Patent Application Publication, Tokukai, No. 2013-223091

### SUMMARY OF INVENTION

### Technical Problem

The device disclosed in Patent Literature 1 has an issue in that, although it is possible to play pack audio, it is not possible to simultaneously play back an image in real time.

According to the invention disclosed in Patent Literature 2, content is watched or listened to by a user after downloading data of a predetermined size for decoding. If full data is to be accumulated, it may be impossible to watch or listen to the content because of insufficient memory.

Furthermore, for carrying out decoding, it is necessary to store data in the first buffer 250, the second buffer 252, the third buffer 254, and then the fourth buffer 266. This necessitates a plurality of memories and makes the process complicated.

In contrast, there is a publicly known technique by which files of an audio signal and an image signal are played back in real time while being received by a user.

However, according to the conventional techniques, it is not possible to deliver an image signal having a high-resolution (44.1 kHz, 16 bit, or 48 kHz, higher than 16 bit) audio signal combined therewith, and therefore it is not possible to play back audio of a quality equivalent to the sound in a live event site.

An object of an aspect of the present invention is to provide a realistic image with sound.

### Solution to Problem

In order to attain the above object, a streaming data generating device in accordance with an aspect of the present invention includes: an embedder configured to (i) acquire a high-resolution audio signal and a 4K image signal which has been converted to HDTV format and (ii) embed the audio signal into the image signal to obtain an embedment signal; an encoder configured to acquire the embedment signal from the embedder and encode the embedment signal by lossless compression to obtain encoded data; and a packager configured to acquire the encoded data from the encoder, convert the encoded data into streaming data, and output the streaming data.

With the configuration, a high-resolution audio signal is embedded into a 4K image signal to obtain an embedment signal, the embedment signal is encoded by lossless compression to obtain encoded data, the encoded data is converted into streaming data, and the streaming data is outputted. This makes it possible to provide a realistic image with sound.

The streaming data generating device in accordance with an aspect of the present invention is configured such that: the embedder is configured to (i) acquire, as the audio signal, a signal representing sound recorded at a real-time live event and (ii) acquire, as the image signal, a signal representing an image captured at the real-time live event; and the packager is configured to output, as the streaming data, data that is capable of being reproduced by a 4K high-resolution content playback application.

With the configuration, a high-quality audio signal and a high-quality image signal are captured in real time, and data that is capable of being reproduced by a 4K high-resolution content playback application is outputted. This makes it possible to provide a realistic image with sound in real time.

The streaming data generating device in accordance with an aspect of the present invention is configured such that: the encoder is configured to carry out compression in accordance with a compression standard called MPEG-4 ALS, the MPEG-4 ALS being a standard in which the embedment signal, together with metadata and synchronization time information, is converted into a file format called container format and encoded by lossless compression; and the packager is configured to convert the encoded data into the streaming data so that the streaming data conforms to a delivery standard called MPEG-DASH.

A streaming data delivery system in accordance with an aspect of the present invention includes: an embedder configured to (i) acquire a high-resolution audio signal and a 4K image signal which has been converted to HDTV format and (ii) embed the audio signal into the image signal to obtain an embedment signal; an encoding/outputting section configured to acquire the embedment signal from the embedder, encode the embedment signal by lossless compression to obtain encoded data, acquire the encoded data, convert the encoded data into streaming data, and output the streaming data; and a delivery server configured to, in response to delivery request information received from a user terminal, acquire the streaming data from the encoding/outputting section and deliver the streaming data.

With the configuration, a high-resolution audio signal is embedded into a 4K image signal to obtain an embedment signal, the embedment signal is encoded by lossless compression to obtain encoded data, the encoded data is converted into streaming data, the streaming data is outputted, and the streaming data is delivered in response to delivery request information. This makes it possible to provide a realistic image with sound corresponding to a user's request.

The streaming data delivery system in accordance with an aspect of the present invention is configured such that: the embedder is configured to acquire an audio signal and an image signal based on a real-time live event; and the encoding/outputting section includes an encoder and a packager.

The configuration makes it possible to provide, in real time, a realistic image with sound corresponding to a user's request.

The streaming data delivery system in accordance with an aspect of the present invention further includes a storage device which has stored therein an audio signal and an image signal based on a live event, and is configured such that: the embedder is configured to acquire the audio signal and the image signal from the storage device in response to the delivery request information; and the encoding/outputting section includes (i) an encoder and a packager or (ii) a program configured to function in the same manner as the encoder and the packager, and a general-purpose device configured to execute the program.

The configuration makes it possible to provide, at any time, a realistic image with sound corresponding to a user's request. Furthermore, the use of a program and a general-purpose device makes it possible to realize the processing carried out by the encoding/outputting section at low cost.

The streaming data delivery system in accordance with an aspect of the present invention further includes a charging server configured to, before or after the delivery server delivers the streaming data, charge a user of the user terminal a fee in response to the delivery request information.

The configuration makes it possible to charge the user a fee for access to a realistic image with sound.

A method of generating streaming data in accordance with an aspect of the present invention includes: an embedding step comprising (i) acquiring a high-resolution audio signal and a 4K image signal which has been converted to HDTV format and (ii) embedding the audio signal into the image signal to obtain an embedment signal; an encoding step comprising acquiring the embedment signal and encoding the embedment signal by lossless compression to obtain encoded data; and an outputting step comprising acquiring the encoded data, converting the encoded data into streaming data, and outputting the streaming data.

With the configuration, a high-resolution audio signal is embedded into a 4K image signal to obtain an embedment signal, the embedment signal is encoded by lossless compression to obtain encoded data, the encoded data is converted into streaming data, and the streaming data is outputted. This makes it possible to provide a realistic image with sound.

### Advantageous Effects of Invention

An aspect of the present invention provides the effect of making it possible to provide a realistic image with sound.

### BRIEF DESCRIPTION OF DRAWINGS

FIG. 1 is a block diagram illustrating Example 1 of a device and method for delivery of streaming data in accordance with an embodiment of the present invention.

FIG. 2 is a block diagram illustrating an Example of a playback device in accordance with an embodiment of the present invention.

FIG. 3 shows a purchase flowchart involving charging and a playback flowchart in accordance with an embodiment of the present invention.

FIG. 4 schematically illustrates an Example of a playback device in accordance with an embodiment of the present invention.

FIG. 5 is a flowchart showing how a playback device in accordance with an embodiment of the present invention operates.

FIG. 6 is a block diagram illustrating a conventional portable audio apparatus display device.

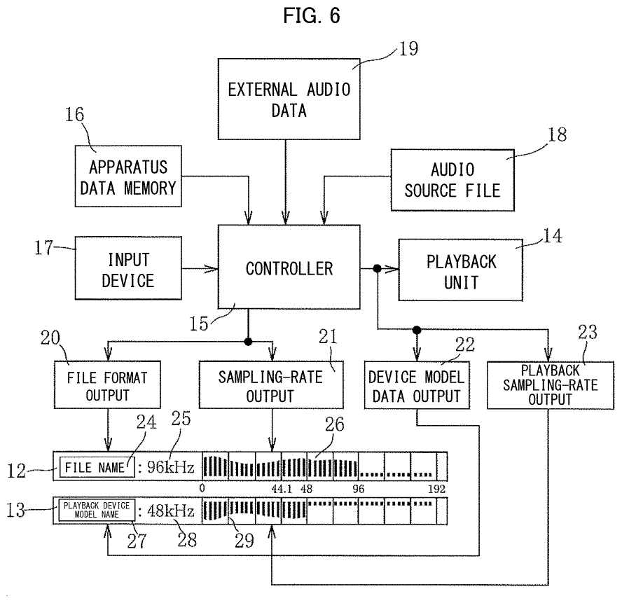

FIG. 7 is a block diagram illustrating an example of a method of playing back streaming data in accordance with an embodiment of the present invention.

### DESCRIPTION OF EMBODIMENTS

The present invention is basically composed of:

an image signal output section 61 configured to convert an image signal captured by an image/audio input section 60 in, for example, a live event site into HDTV format and output the image signal;

an audio signal output section 62 configured to convert an audio signal recorded by the image/audio input section 60 into a high-resolution audio signal and output the high-resolution audio signal;

an embedder 63 which is connected to the image signal output section 61 and the audio signal output section 62 and which is configured to embed the high-resolution audio signal outputted from the audio signal output section 62 into the image signal outputted from the image signal output section 61;

an encoder 64 which is connected to the embedder 63 and which is configured to carry out encoding by lossless compression;

a packager 30 configured to convert the data from the encoder 64 into streaming data; and

a playback device 52 which is connected to the packager 30 via one or more delivery servers 65 and internet 67 and which is incapable of recording.

In a preferred embodiment, the playback device 52 is characterized in that, in order to realize a system in which content is only accessible upon payment of a fee, the playback device 52 is capable of being coupled to a ticketing/authentication server which is connected to the Internet and which is for ticketing and authentication.

More specifically, the encoder 64 uses MPEG-4 ALS, which converts a high-resolution, high-quality (hereinafter referred to as “high-resolution”) audio signal and an image signal, together with metadata and synchronization time information etc., into a file format called container format and encodes it by lossless compression.

In a preferred embodiment, the packager 30 preferably uses MPEG-DASH, which converts data compressed by the encoder 64 into streaming data. Note, however, that the packager 30 is not limited to this standard.

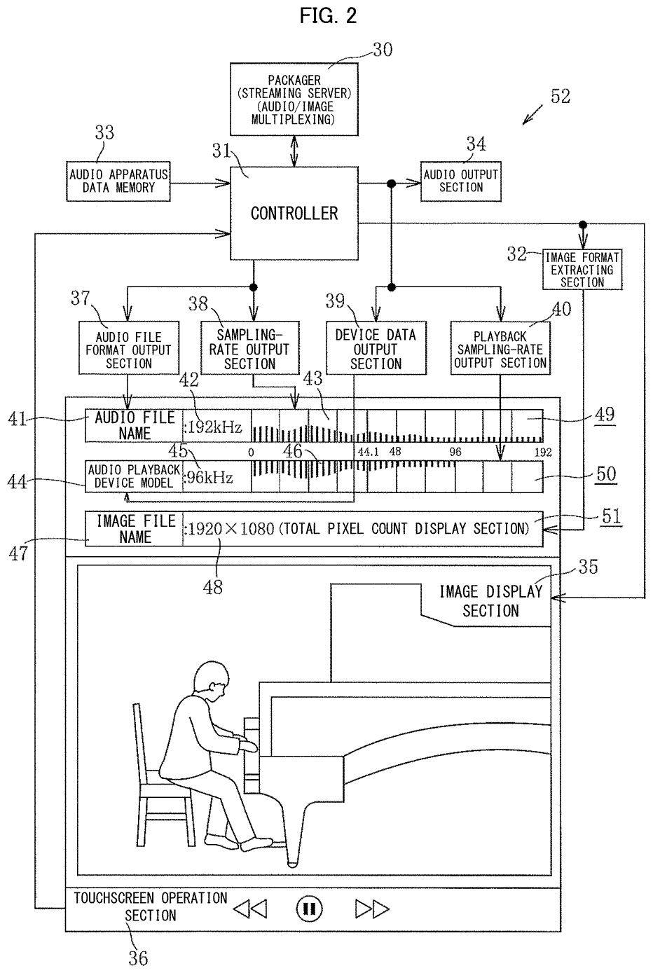

As illustrated in FIG. 2, the playback device 52 on which an end user plays back streaming data includes: a controller 31 which acquires, from the packager 30, streaming data in which image data and high-resolution audio data are multiplexed, decodes the streaming data, and outputs the decoded data; an audio output section 34 which is capable of playing back the decoded audio outputted from the controller 31; an image display section 35 which displays the decoded image outputted from the controller 31; an audio data display section 49 which displays the format of audio data acquired from the packager 30; an audio playback data display section 50 which displays a format that the playback device 52 has; and an image data display section 51 which displays the format of the image outputted from the controller 31.

The audio data display section 49 includes a file name display section 41, a first numeric value display section 42, and a first bar chart display section 43. The audio playback data display section 50 includes an audio playback device model name display section 44, a second numeric value display section 45, and a second bar chart display section 46. The image data display section 51 includes an image file name display section 47 and a total pixel count display section 48.

The controller 31 has the function of decoding, by MPEG-4 ALS (which is a lossless compression tool), streaming data which has been converted to conform to MPEG-DASH and which has been received from the packager 30. Note that the controller 31 may be dedicated hardware or may be a general-purpose device (e.g., PC, server) which has, installed thereon, software realizing the function of the controller 31.

A method of delivering streaming data in accordance with the present invention includes the following steps.

(1) Step of converting an image signal captured by the image/audio input section 60 in a live event site etc. into HDTV format at the image signal output section 61 and outputting the image signal.

(2) Step of converting an audio signal recorded by the image/audio input section 60 into a high-resolution audio signal at the audio signal output section 62.

(3) Step of embedding, at the embedder 63, the high-resolution audio signal obtained through conversion in the step (2) into the image signal converted to HDTV format in the step (1).

(4) Step of encoding, at the encoder 64 using MPEG-4 ALS, the image signal which had the high-resolution audio signal embedded therein in the step (3), by lossless compression,

(5) Step of converting, at the packager 30 using MPEG-DASH, the data compressed in the step (4) into streaming data.

(6) Step of decoding, with a decoder using MPEG-4 ALS (which is a lossless compression tool), the streaming data which was transmitted from the packager 30 to each delivery server 65 in the step (5) and received at an end user's playback device 52 via the internet 67, without distortion.

(7) Step of, in order to realize a system in which content is only accessible upon payment of a fee, coupling the playback device to a ticketing/authentication server which is connected to the Internet and which is for ticketing and authentication.

### Example 1

The following description will discuss a device and method for delivery of streaming data in accordance with Embodiment 1 of the present invention, with reference to drawings.

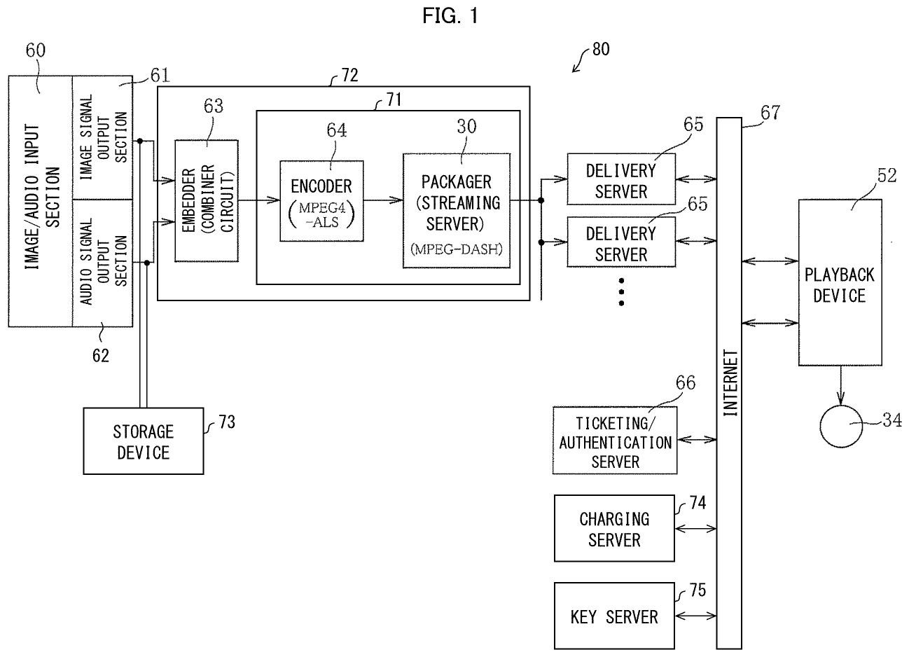

The image/audio input section 60 in FIG. 1 is for use in anywhere in which an image and sound can be inputted in real time with realism, such as a concert hall, a live event site, a site from which a sport is broadcast, and natural world such as train sound and wild bird sound. The image/audio input section 60 is provided with: the image signal output section 61 which converts a captured image signal into, for example, 2K (1920×1080 pixels) HDTV format (still image or moving image) and outputs the image signal; and the audio signal output section 62 which converts an audio signal recorded by the image/audio input section 60 in the above-stated live event site or the like into, for example, a high-resolution audio signal of 24 bits/96 kHz. The term “high-resolution audio signal” refers to a signal having a higher sampling frequency and quantization bit depth than CD-DA specifications (44.1 kHz/16 bits) or DAT specifications (48.0 kHz/16 bit).

The resolution of the image is not limited to 2K, and may be 4K, 8K, or the like.

The image signal output section 61 and the audio signal output section 62 are connected to the embedder 63, which is a combiner circuit, and the embedder 63 embeds the high-resolution audio signal into the image signal. The embedder 63 is connected to the encoder 64. The encoder 64 uses MPEG-4 Audio Lossless Coding (MPEG-4 ALS) (which is a global standard for lossless encoding), is compatible with high-resolution audio, and is configured to (i) convert the high-resolution audio signal and the image signal, along with metadata and synchronization time information etc., into a file format called container format and (ii) encode it by lossless compression. The encoder 64 is connected to the packager 30, which is a streaming server. The packager 30 uses MPEG-Dynamic Adaptive Streaming over HTTP (MPEG-DASH) (which is a global standard), and is configured to convert the data compressed by the encoder 64 into streaming data.

The streaming data is transmitted from the packager 30 to each delivery server 65, and is received by the end user's playback device 52 via the internet 67.

As illustrated in FIG. 1, a streaming data generating device 72 includes the embedder 63, the encoder 64, and the packager 30. The embedder 63 acquires a high-resolution audio signal and a 4K image signal which has been converted to HDTV format, and embeds the audio signal into the image signal to obtain an embedment signal (embedding step). The encoder 64 acquires the embedment signal from the embedder 63 and encodes the embedment signal by lossless compression to obtain encoded data (encoding step). The packager 30 acquires the encoded data from the encoder 64, converts the encoded data into streaming data, and outputs the streaming data (outputting step).

Furthermore, the embedder 63 may acquire, as the high-resolution audio signal, a signal representing sound recorded at a real-time live event and acquire, as the 4K image signal, a signal representing an image captured at the real-time live event. The packager 30 may output, as the streaming data, data that is capable of being reproduced by a 4K high-resolution content playback application.

The 4K high-resolution content playback application is an application program capable of reproducing content that contains high-resolution audio and a 4K image as-is with their high audio quality and high image quality maintained. The 4K high-resolution content playback application is installed on a smartphone, a tablet, a personal computer, an Android (registered trademark) TV, or the like and launched, and the content is thereby played back.

The encoder 64 may carry out compression in accordance with a compression standard called MPEG-4 ALS. In MPEG-4 ALS, the embedment signal (obtained by embedding the high-resolution audio signal into the 4K image signal), together with metadata and synchronization time information, is converted into a file format called container format and encoded by lossless compression. The packager 30 may convert the encoded data into the streaming data so that the streaming data conforms to a delivery standard called MPEG-DASH.

As illustrated in FIG. 1, a streaming data delivery system 80 includes the embedder 63, an encoding/outputting section 71, and the one or more delivery servers 65. The embedder 63 acquires a high-resolution audio signal and a 4K image signal which has been converted to HDTV format and embeds the high-resolution audio signal into the 4K image signal to obtain an embedment signal. The encoding/outputting section 71 acquires the embedment signal (obtained by embedding the high-resolution audio signal into the 4K image signal) from the embedder 63, encodes the embedment signal by lossless compression to obtain encoded data, acquires the encoded data, converts the encoded data into streaming data, and outputs the streaming data. Each delivery server 65 acquires the streaming data from the encoding/outputting section 71 and delivers the streaming data via the internet 67, in response to delivery request information received from the playback device (user terminal) 52 via the internet 67.

Furthermore, in a case where the streaming data delivery system 80 delivers an image with sound in real time, it is preferable that: the embedder 63 acquire an audio signal and an image signal based on a real-time live event; and the encoding/outputting section 71 include the encoder 64 and the packager 30.

On the contrary, in a case where the streaming data delivery system 80 delivers an image with sound by means of Video On Demand (VOD), it is preferable that the streaming data delivery system 80 further include a storage device 73 which has stored therein an audio signal and an image signal based on a live event. As illustrated in FIG. 1, the storage device 73 is connected to the image signal output section 61, the audio signal output section 62, and the embedder 63. The storage device 73 acquires an image signal from the image signal output section 61 and stores the image signal therein, and acquires an audio signal from the audio signal output section 62 and stores the audio signal therein.

It is also preferable that: the embedder 63 read (acquire) the audio signal and the image signal from the storage device 73 in response to the delivery request information received from the playback device 52; and the encoding/outputting section 71 include (i) the encoder 64 and the packager 30 or (ii) a program which functions in the same manner as the encoder 64 and the packager 30 and a general-purpose device which executes the program.

The program is, for example, a microprogram which controls a wired logic of the encoder 64 and the packager 30. The general-purpose device is, for example, a PC, a server, or the like which is capable of executing the program.

Note that, in a case where an image with sound is delivered by means of VOD, the streaming data to be delivered may be encrypted. In this case, the packager 30 or the combination of the program and the general-purpose device further encrypts the streaming data which has been converted to conform to MPEG-DASH, and transfers the encrypted streaming data to each delivery server 65. On the other hand, the playback device 52 receives the encrypted streaming data from the delivery server 65, decodes the streaming data, and then carries out playback.

The playback device 52 carries out decoding by running a pre-installed application. Specifically, for example, a key server 75 is provided which is capable of communicating with the playback device 52. The playback device 52 receives the streaming data from the delivery server 65 while acquiring data of a key from the key server 75, and decodes the streaming data.

The streaming data delivery system 80 may further include a charging server 74 which charges a user of the playback device 52 a fee in response to delivery request information received from the playback device 52, before or after the delivery server 65 delivers the streaming data. As illustrated in FIG. 1, the charging server 74 is configured to be capable of transmitting and receiving data to and from the delivery servers 65, the ticketing/authentication server 66, and the playback device 52 via the internet 67.

The playback device 52 includes, as illustrated in FIG. 2, the image display section 35 and a touchscreen operation section 36 which are provided separately, and has the audio output section 34 such as earphones connected thereto. The image display section 35 is provided with the audio data display section 49, the audio playback data display section 50, and the image data display section 51.

The playback device 52 includes the controller 31. The controller 31 functions as a decoder using the foregoing MPEG-4 ALS (which is a lossless compression tool), and decodes, without distortion, sampled streaming data composed of a high-resolution audio signal and an image signal compressed by the encoder 64.

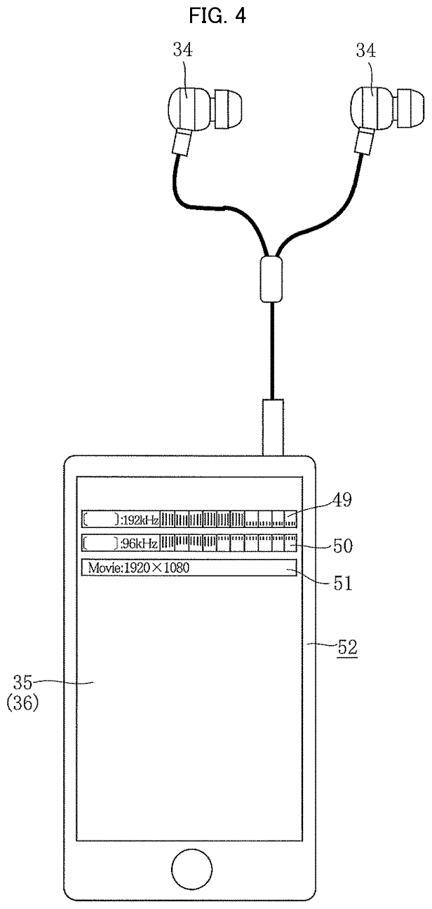

As illustrated in FIG. 4, the controller 31 has connected thereto, as hardware: the audio output section 34 composed of earphones, a speaker, and/or the like; the image display section 35 which displays images (moving image or still image); an image format extracting section 32 which extracts the format of an image; an audio apparatus data memory 33 which has stored therein device model data that the playback device 52 has; and the touchscreen operation section 36 such as a touchscreen, switch, and/or the like.

The controller 31 further has, connected thereto: an audio file format output section 37 which outputs the name of the format of an audio file inputted from the packager 30; and a sampling-rate output section 38 which analyzes and outputs the sampling rate of the audio file inputted from the packager 30. The audio file format output section 37 and the sampling-rate output section 38 are connected to the audio data display section 49. The audio data display section 49 includes the file name display section 41, the first numeric value display section 42, and the first bar chart display section 43.

The controller 31 has, connected to its audio output section 34-side output: a device data output section 39 which outputs device model data acquired from the audio apparatus data memory 33; and a playback sampling-rate output section 40 which analyzes and outputs playback sampling of the playback device 52 which is currently in use. The device data output section 39 and the playback sampling-rate output section 40 are connected to the audio playback data display section 50. The audio playback data display section 50 includes the audio playback device model name display section 44, the second numeric value display section 45, and the second bar chart display section 46.

The playback device 52 includes the touchscreen operation section 36. The playback device 52 is connected to the ticketing/authentication server 66 for ticketing and authentication, which is connected to the internet 67. An operation on the touchscreen operation section 36 causes the playback device 52 to be capable of communicating with the ticketing/authentication server 66.

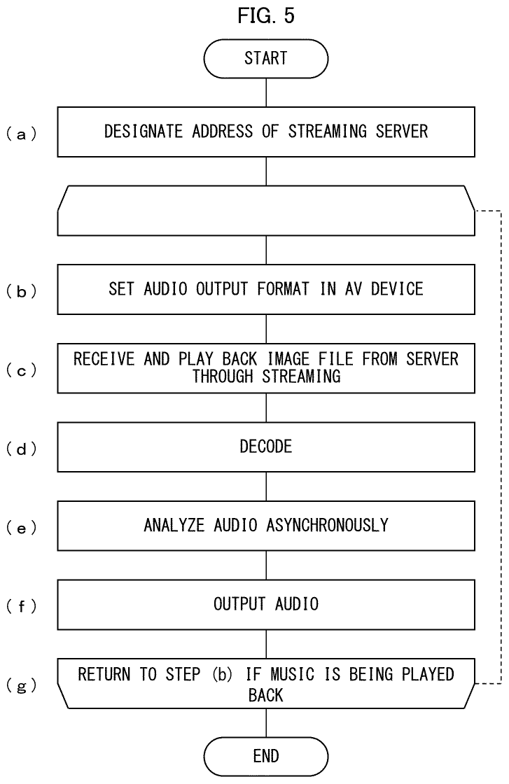

The playback device 52, which is configured as described above, provides the following effects, which are described with reference to FIG. 5.

(a) A process is started with switching ON the playback device 52. A user designates, via the touchscreen operation section 36, the address of data that the user wants to load into the controller 31. The packager 30 converts, into streaming data conforming to a delivery standard called MPEG-DASH, data obtained by multiplexing and encoding an image with a large number of pixels, such as 2K, 4K, or 8K image, and high-quality audio.

(b) Once the address has been designated as described above, setting of audio output format is carried out in the playback device 52.

(c) The playback device 52 receives the streaming data form the packager 30 and temporarily stores it in a memory. The playback device 52 does not leave the streaming data undeleted in the memory after playing back the streaming data.

(d) The controller 31 decodes data converted with MPEG-DASH, with the foregoing MPEG-4 ALS (which is a lossless compression format). The controller 31 issues a screen output instruction and an audio output instruction.

(e) The controller 31 carries out an audio analysis asynchronously.

(f) The audio output section 34 outputs audio, and the image display section 35 displays a moving image or a still image.

(g) In a case where a piece of music is being played back, the playback device 52 returns to the step (b) and repeats the steps (b) to (f).

Meanwhile, the audio file format output section 37 outputs a file name from the audio data loaded into the controller 31, and causes the file name display section 41 of the audio data display section 49 to display the file name. The sampling-rate output section 38 analyzes the frequency of the audio data, converts the frequency into sampling rate, causes numeric data indicative of the sampling rate to be displayed in digital form, e.g., “192 kHz”, and causes the first bar chart display section 43 to display, in analog form, the sampling rate in the form of a tightly spaced bar chart from 0 kHz to 192 kHz so that the sampling rate can be recognized at a glance.

The device data output section 39 outputs a model name of the playback device 52 from the playback data which is being outputted from the controller 31 toward the audio output section 34, and causes the audio playback device model name display section 44 of the audio playback data display section 50 to display the model name. Meanwhile, the second numeric value display section 45 outputs a sampling rate during playback based on frequency data that the playback device 52 has, and causes numeric data indicative of the sampling rate to be displayed in digital form, e.g., “96 kHz”. The second bar chart display section 46 displays, in analog form, a tightly spaced bar chart from 0 kHz to 96 kHz so that the sampling rate can be recognized at a glance.

Furthermore, the image format extracting section 32 extracts an image format from image data which is being outputted from the controller 31 toward the image display section 35, causes the image file name display section 47 of the image data display section 51 to display an image file name, and causes the total pixel count display section 48 to display total pixel count.

By carrying out display in such a manner, it is possible to recognize, at a glance, that the playback is being carried out at 96 kHz although the audio data acquired from the packager 30 is 192 kHz. This makes it possible to understand, at a glance, that the playback device 52 that is playing back the acquired audio data is not capable of playing back the audio data sufficiently.

Furthermore, if display on the audio data display section 49 and display on the audio playback data display section 50 are the same, it is possible to understand from this that the playback device 52 is carrying out playback making full use of audio data.

The image format extracting section 32 causes the total pixel count display section 48 of the image data display section 51 to display total pixel count. This makes it possible to understand that the image is a high-quality image.

The playback device 52 in accordance with the present invention enables live streaming of high-resolution audio. This provides a user with a whole new music listening experience. The delivery system 80 uses the image/audio input section 60 to deliver powerful music played at a live event site etc. along with a moving image in real time via live streaming. This allows the user to enjoy the original sound of a realistic, high-audio-quality live performance at a different place even when the user cannot visit the site of the live performance.

The playback device 52 in accordance with the present invention is intended to be a portable audio/image apparatus such as a tablet or a smartphone; however, the playback device 52 is not necessarily limited to portable ones. Note that, although the playback device 52 plays back streaming data, the playback device 52 is not capable of recording the acquired image data or audio data.

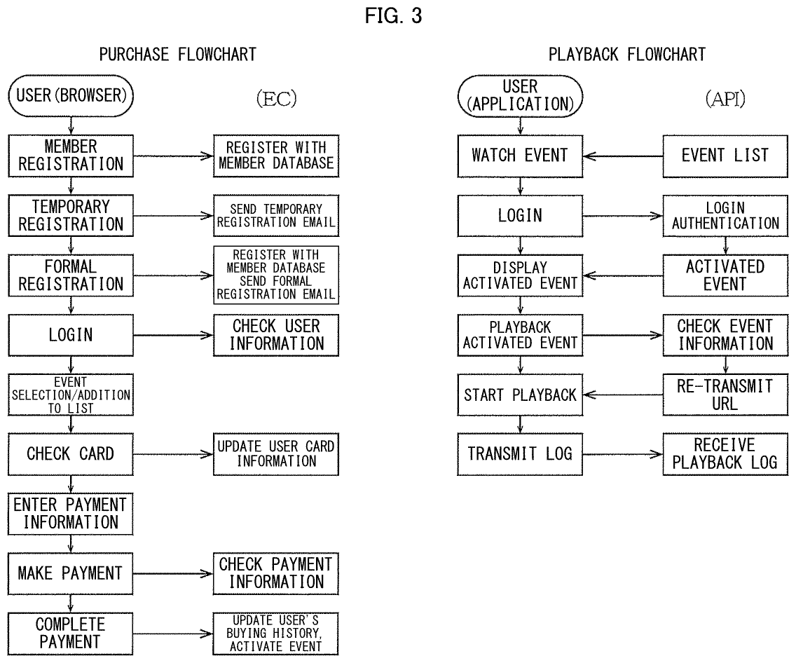

The following description will discuss a method of making content only accessible upon payment of a fee, with reference to FIG. 3.

(a) With use of a system in which content is only accessible upon payment of a fee, an end user operates the touchscreen operation section 36 of the playback device 52 to log in to the ticketing/authentication server 66 (which is for ticketing and for authentication and which is connected to the internet 67) and makes a member registration. More specifically, in the purchase flowchart shown in FIG. 3, once the user has made a member registration, member information is stored in a member database (DB) for electronic commerce (EC). When a temporary registration is made, a temporary registration email is sent from the ticketing/authentication server 66 to the playback device 52. When a formal registration is made, a formal registration email is sent from the ticketing/authentication server 66 to the playback device 52.

When the user has logged in to the ticketing/authentication server 66 after the formal registration of the member information has been done, the user checks the member information, selects an event, adds items to a list, and checks a card of the user. The ticketing/authentication server 66 updates the information on the card of the user.

The user enters payment information and makes a payment. The payment information is information about a credit card, e-money, or the like. The ticketing/authentication server 66 verifies the payment information. The user completes the payment. The ticketing/authentication server 66 updates the user's buying history, and records a purchase event.

(b) Next, in the playback flowchart in FIG. 3, the end user sends a request for a work list to a portal site. The work list is transmitted to the playback device 52 via Application Programming Interface (API). After the user logs in and the login is authenticated, a “paid” event is transmitted to the playback device 52.

The end user sends a request for a URL to the ticketing/authentication server 66. The ticketing/authentication server 66 generates a one-time URL, and the delivery server 65 transmits the one-time URL to the playback device 52.

Once the end user has sent a request for playback to the delivery server 65, a work list response is transmitted to the ticketing/authentication server 66. Once the ticketing/authentication server 66 has made a token-based authentication of the work list response and a “successfully authenticated” response has been transmitted to the delivery server 65, the delivery server 65 carries out streaming delivery to the end user's playback device 52.

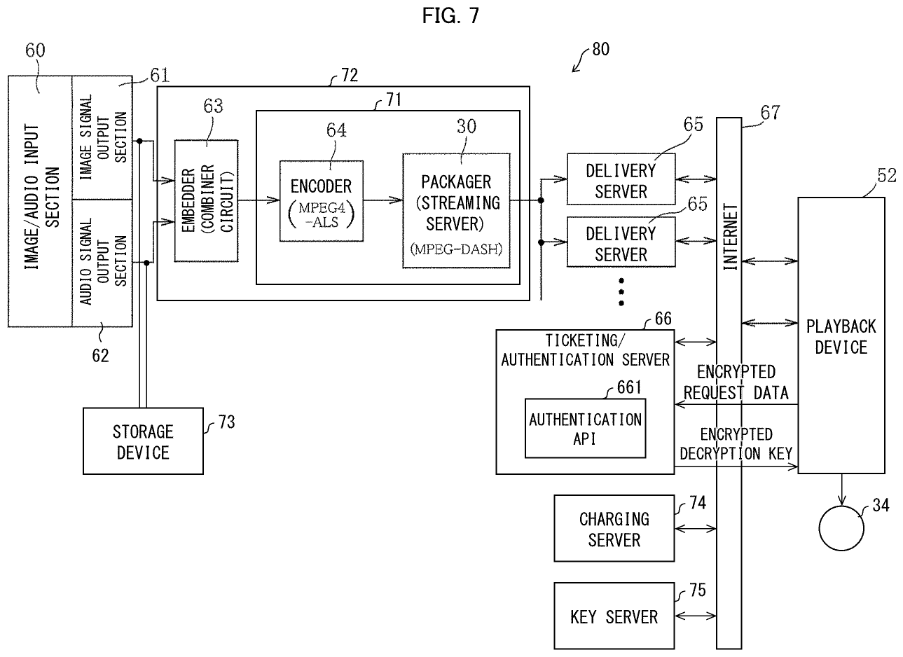

Furthermore, an example of a method of playing back streaming data by the playback device 52 is discussed. The playback device 52 receives and plays back encrypted streaming data containing a high-resolution audio signal and a 4K image signal. The following description will discuss the details thereof with reference to FIG. 7.

First, the playback device 52 encrypts, by a predetermined method, request data indicative of a request for a key for decoding the streaming data (encrypting step). The request data contains a public key corresponding to a secret key that the playback device 52 has. Next, the playback device 52 transmits, to the ticketing/authentication server 66, the encrypted request data encrypted in the encrypting step (transmitting step).

On the other hand, the ticketing/authentication server 66 receives the encrypted request data from the playback device 52. Next, the ticketing/authentication server 66 decodes the request data by a predetermined method. Next, the ticketing/authentication server 66 acquires, using an authentication Application Programing Interface (API) 661, the key for decoding the streaming data from the key server 75, in accordance with a request indicated by the decoded request data. The decoding key is one that has been encrypted by the key server 75 with the public key received from the playback device 52. Then, the ticketing/authentication server 66 transmits the acquired decoding key to the playback device 52.

The playback device 52 acquires the encrypted decoding key from the ticketing/authentication server (recipient in the transmitting step) 66 (acquiring step). Next, the playback device 52 decodes the acquired decoding key with the secret key (decoding step). This causes the playback device 52 to be ready for the playback of streaming data.

Next, the playback device 52 receives the streaming data from the delivery server 65 (receiving step). Then, the playback device 52 decodes, with the decoding key, the streaming data received in the receiving step, and plays back the decoded streaming data (playback step).

[Additional Remarks]

The invention in accordance with Aspect 1 is a streaming data delivery device including: an image signal input section configured to convert an image signal captured by an image/audio output section into HDTV format and output the image signal; an audio signal input section configured to convert a audio signal recorded by the image/audio output section into a high-resolution audio signal; an embedder which is connected to the image signal input section and the audio signal input section and which is configured to embed the high-resolution audio signal into the image signal; an encoder which is connected to the embedder and which is configured to carry out encoding by lossless compression; a packager configured to convert the data from the encoder into streaming data; and a playback device which is connected to the packager via a delivery server and the Internet and which is incapable of recording, in which, in order to realize a system in which content is only accessible upon payment of a fee, the playback device is capable of being coupled to a ticketing/authentication server which is connected to the Internet and which is for ticketing and authentication.

With the configuration, the playback device is, in order to realize a system in which content is only accessible upon payment of a fee, capable of being coupled to the ticketing/authentication server which is connected to the Internet and which is for ticketing and authentication. This makes it possible, in streaming in which a file containing a high-resolution audio signal and an image signal is played back in real time by a user while being received by the user, to deliver an image signal combined with an audio signal of higher quality than ever before. It is also possible to provide a system in which content is only accessible upon payment of a fee. Employment of a system in which content is only accessible upon payment of a fee ensures that the original audio provided by an artist delivered in streaming to the user, i.e., artist's master audio recording, is protected and ensures that the artist receives remuneration in the form of a ticket fee.

The invention in accordance with Aspect 2 is configured such that: the encoder uses MPEG-4 ALS which converts a high-resolution audio signal and an image signal, together with metadata and synchronization time information etc., into a file format called container format and encodes it by lossless compression; and the packager uses MPEG-DASH which converts the data compressed by the encoder into streaming data.

With the configuration, it is possible to provide a playback device that encodes streaming data containing a high-resolution audio signal by lossless compression and that converts the compressed data into streaming data.

The invention in accordance with Aspect 3 is configured such that the playback device includes: a controller configured to acquire, from a packager, streaming data in which image data and high-resolution audio data are multiplexed and decode the streaming data; an audio output section which is capable of playing back high-resolution audio outputted from the controller; an image display section configured to display an image outputted from the controller; an audio data display section configured to display the format of audio data acquired from the packager; an audio playback data display section configured to display a format that the playback device has; and an image data display section configured to display the format of the image outputted from the controller.

The configuration enables live streaming of high-resolution audio. This provides a user with a whole new music listening experience. Since the configuration enables delivering powerful music played by an image/audio output section in a live event site etc. along with a moving image in real time via live streaming, it is possible to allow the user to enjoy the original sound of a realistic, high-quality-audio live performance at a different place even when the user cannot visit the site of the live performance.

The invention in accordance with Aspect 4 is configured such that: the audio data display section includes a file name display section, a first numeric value display section, and a first bar chart display section; the audio playback data display section includes an audio playback device model name display section, a second numeric value display section, and a second bar chart display section; and the image data display section includes an image file name display section and a total pixel count display section.

With the configuration, it is possible to recognize, at a glance, that the playback is being carried out at 96 kHz although the audio data acquired from a streaming server is 192 kHz. This makes it possible to understand, at a glance, that the playback device that is using the acquired audio data is not playing back the audio data sufficiently.

Furthermore, if display on the audio data display section and display on the audio playback data display section are the same, it is possible to understand from this that the playback device is carrying out playback making full use of audio data.

Furthermore, the total pixel count display section of the image data display section displays total pixel count. This makes it possible to understand that the image is a high-quality image.

The invention in accordance with Aspect 5 is configured such that the controller has the function of decoding, with MPEG-4 ALS (which is a lossless compression tool), streaming data which has been converted to conform to MPEG-DASH and which has been received from the packager.

With the configuration, the playback device can be employed not only for a portable apparatus such as a tablet or a smartphone but also an apparatus not portable such as a personal computer.

The invention in accordance with Aspect 6 is a method of playing back streaming data, including the steps of: (1) converting an image signal captured by an image/audio output section into HDTV format at an image signal input section and outputting the image signal; (2) converting an audio signal recorded by the image/audio output section into a high-resolution audio signal at an audio signal input section; (3) embedding, at an embedder, the high-resolution audio signal converted in the step (2) into the image signal converted to HDTV format in the step (1); (4) encoding, at an encoder using MPEG-4 ALS, the image signal which had the high-resolution audio signal embedded therein in the step (3), by lossless compression; (5) converting, at a packager using MPEG-DASH, the data compressed in the step (4) into streaming data; (6) decoding, with a decoder using MPEG-4 ALS (lossless compression tool), the streaming data which was transmitted from the packager to each delivery server in the step (5) and received at an end user's unrecordable playback device via the Internet, without distortion; and (7) in order to realize a system in which content is only accessible upon payment of a fee, coupling the playback device to a ticketing/authentication server which is connected to the Internet and which is for ticketing and authentication.

With the configuration, it is possible to provide a method of delivering streaming data in which a file containing a high-resolution audio signal and an image signal is played back in real time by a user while being received by the user. It is also possible to provide a system in which content is only accessible upon payment of a fee. Employment of a system in which content is only accessible upon payment of a fee ensures that the original audio provided by an artist delivered in streaming to the user, i.e., artist's master audio recording, is protected and ensures that the artist receives remuneration in the form of a ticket fee.

### REFERENCE SIGNS LIST

10 portable audio apparatus main unit
11 display section
12 audio source output display section
13 playback output display section
14 playback unit
15 controller
16 apparatus data memory
17 input device
18 audio source file
19 external audio data
20 file format output
21 sampling-rate output
22 device model data output
23 playback sampling-rate output
24 file name display section
25 numeric value display section
26 bar chart display section
27 playback device model name display section
28 numeric value display section
29 bar chart display section
30 streaming server
31 controller
32 image format extracting section
33 audio apparatus data memory
34 audio output section
35 image display section
36 touchscreen operation section
37 audio file format output section
38 sampling-rate output section
39 device data output section
40 playback sampling output section
41 file name display section
42 first numeric value display section
43 first bar chart display section
44 audio playback device model name display section
45 second numeric value display section
46 second bar chart display section
47 image file name display section
48 total pixel count display section
49 audio data display section
50 audio playback data display section
51 image data display section
52 playback device (user terminal)
60 image/audio input section in live event site etc.
61 image signal output section
62 audio signal output section
63 embedder
64 encoder
65 packager
66 ticketing/authentication server
67 internet
71 encoding/outputting section
72 streaming data generating device
73 storage device
74 charging server
75 key server

1-8. (canceled)

9. A streaming data generating device, comprising:
an embedder configured to (i) acquire a high-resolution audio signal and a 4K image signal which has been converted to HDTV format and (ii) embed the audio signal into the image signal to obtain an embedment signal;
an encoder configured to acquire the embedment signal from the embedder and encode the embedment signal by lossless compression to obtain encoded data; and
a packager configured to acquire the encoded data from the encoder, convert the encoded data into streaming data, and output the streaming data.

10. The streaming data generating device as set forth in claim 9, wherein:
the embedder is configured to (i) acquire, as the audio signal, a signal representing sound recorded at a real-time live event and (ii) acquire, as the image signal, a signal representing an image captured at the real-time live event; and
the packager is configured to output, as the streaming data, data that is capable of being reproduced by a 4K high-resolution content playback application.

11. The streaming data generating device as set forth in claim 9, wherein:
the encoder is configured to carry out compression in accordance with a compression standard called MPEG-4 ALS, the MPEG-4 ALS being a standard in which the embedment signal, together with metadata and synchronization time information, is converted into a file format called container format and encoded by lossless compression; and
the packager is configured to convert the encoded data into the streaming data so that the streaming data conforms to a delivery standard called MPEG-DASH.

12. A streaming data delivery system, comprising:
an embedder configured to (i) acquire a high-resolution audio signal and a 4K image signal which has been converted to HDTV format and (ii) embed the audio signal into the image signal to obtain an embedment signal;
an encoding/outputting section configured to acquire the embedment signal from the embedder, encode the embedment signal by lossless compression to obtain encoded data, acquire the encoded data, convert the encoded data into streaming data, and output the streaming data; and
a delivery server configured to, in response to delivery request information received from a user terminal, acquire the streaming data from the encoding/outputting section and deliver the streaming data.

13. The streaming data delivery system as set forth in claim 12, wherein:
the embedder is configured to acquire an audio signal and an image signal based on a real-time live event; and
the encoding/outputting section includes an encoder and a packager.

14. The streaming data delivery system as set forth in claim 12, further comprising a storage device which has stored therein an audio signal and an image signal based on a live event, wherein:
the embedder is configured to acquire the audio signal and the image signal from the storage device in response to the delivery request information; and
the encoding/outputting section includes (i) an encoder and a packager or (ii) a program configured to function in the same manner as the encoder and the packager, and a general-purpose device configured to execute the program.

15. The streaming data delivery system as set forth in claim 12, further comprising a charging server configured to, before or after the delivery server delivers the streaming data, charge a user of the user terminal a fee in response to the delivery request information.

16. A method of generating streaming data, comprising:
an embedding step comprising (i) acquiring a high-resolution audio signal and a 4K image signal which has been converted to HDTV format and (ii) embedding the audio signal into the image signal to obtain an embedment signal;
an encoding step comprising acquiring the embedment signal and encoding the embedment signal by lossless compression to obtain encoded data; and
an outputting step comprising acquiring the encoded data, converting the encoded data into streaming data, and outputting the streaming data.
